(19) United States
(12) Patent Application Publication
(10) Pub. No.: US 2003/0197742 A1
(43) Pub. Date: Oct. 23, 2003

(54) Method and apparatus of integrating audio and video hardware with a control system

(75) Inventors: Steven M. Cohan, Madison, WI (US); Michael Konkle, Sauk City, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: INTELIX, L.L.C., Middleton, WI (US)

(21) Appl. No.: 10/417,505

(22) Filed: Apr. 17, 2003

Related U.S. Application Data
(60) Provisional application No. 60/373,358, filed on Apr. 17, 2002.

(51) Int. Cl. G09G 5/00

(52) U.S. Cl. 345/853

(57) ABSTRACT

An apparatus and method of integrating audio and video hardware with an external control system. The method includes the steps of compiling control strings associated with a corresponding plurality of functions of the hardware in a GUI. Then, the method includes selecting a function via the GUI so as to automatically generate a selected control string. The selected control string is then inputted to an external control system program.

### BACKGROUND OF THE INVENTION

1. Field of the Invention

The present invention is directed to integrating low voltage equipment with an external control system, and more particularly, integrating audio, video, and related devices with a control system by providing a tool to allow automatic programming of system functions.

2. Description of Related Art

Audio and video system programmers experience difficulty creating control statements required to manipulate variables within audio, video and related devices. This activity currently requires a working knowledge of device architecture and system functions specific to each manufacturer's product. Often the programmer consumes many hours sifting through protocol documentation to understand and create the required control syntax. Overall, the primary problem was the manual task of interfacing system hardware with an external controller. Therefore, the art of system design of low voltage components was in need of a solution that automates the programming process, thus eliminating barriers associated with system integration with the program of an external control system.

### SUMMARY OF THE INVENTION

The preferred embodiment overcomes the drawbacks of prior art systems by creating a stable of software tools incorporating informational, visually oriented modules (as opposed to text strings) that guide the programmer through the process of programming specific manufacturer's hardware devices. The first release is a programmer's design aid, known as the Programmer's Message Compiler.

According to a first aspect of the preferred embodiment, a method of integrating audio and video hardware with an external control system includes the steps of compiling control strings associated with a corresponding plurality of functions of the hardware in a Graphical User Interface (GUI). Then, the method includes selecting a function via the GUI so as to generate a selected control string. The selected control string is thereafter inputted to an external control system program, either manually or automatically. This software module can reside inside a software control program or as a stand-alone software program.

In another aspect of the preferred embodiment, a method of integrating audio and video hardware with an external control system includes generating a decision tree menu system based on the functions of the hardware, each function being associated with a corresponding control string. Thereafter, the method includes selecting a function via the decision tree. Finally, the method includes automatically or manually determining a control string based on the selecting step.

According to an alternate aspect of the preferred embodiment, a method of programming a plurality of audio, video and related hardware functions is provided. The steps of generating a decision tree associated with the plurality of functions of the hardware are automatically defined from minimal human interaction in a GUI. Functions are selected via the GUI so as to acquire a control string associated with the selected function. Then, the method includes inputting the control string in an external control system program.

These and other objects, features, and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A preferred exemplary embodiment of the invention is illustrated in the accompanying drawings in which like reference numerals represent like parts throughout, and in which:

FIG. 1A is a block diagram of a system for more efficiently interfacing a control system with audio/video hardware components;

FIG. 1B is a block diagram of the interface of FIG. 1A;

FIG. 2 is a flow chart illustrating a method of the preferred embodiment;

FIG. 3 is a computer screen snapshot of use of a decision tree according to the preferred embodiment; and

FIGS. 4A-4D are computer screen snapshots illustrating operation of the preferred embodiment.

### DETAILED DESCRIPTION OF THE PREFERRED EMBODIMENT

The preferred embodiment of the present invention yields a complete list of selected hardware product's functional capabilities, which represent simple understandable flow patterns that are visually appealing. Through interaction with the software, the user progressively refines the desired action and provides further refinement possibilities.

Moreover, the invention virtually eliminates the need to decipher specific syntax of a specific manufacturer's product. Importantly, the preferred embodiment eliminates the need to retype command strings noted in the manufactured product RS232 programming manual; rather, strings are automatically produced as the result of the programmer's actions. As a result, the chance of typographical errors is eliminated. The method also creates specific syntax required for all major control manufacturers.

The preferred embodiment is also directed to providing a visually oriented software utility to allow the systems' hardware installer access to diagnostic, setup and refinement functions. In particular, the system has the ability to operate “in reverse” to find strings associated with the hardware components (“snooping”), and compare against the programmer's strings as a diagnostic check.

The preferred embodiment includes a modular code builder. This product is an offshoot to the Programmer's Message Compiler that automatically creates control system syntax-specific objects intended for direct placement in control system operating software environments.

The preferred embodiment of InteliTool™ is a comprehensive toolkit, which manages the process of integrating Intelix mixers with AMX, Crestron, and other control systems. The software utility greatly simplifies the task of creating external control interfaces for Intelix mixers by generating cut-and-paste control strings from a user-selected function list.

Using InteliTool's intuitive menu tree system to pinpoint, for example, the mixer control they wish to emulate—volume control, source selection, page routing, etc.—programmers simply select the desired function, and InteliTool automatically and instantly displays the RS232 string required for integration. This string can then be communicated, i.e., cut and pasted, to AMX, Crestron, and other external control system development software, eliminating hours of programmer manual research, calculating various parameters, and typing in long lines of cumbersome hexidecimal based control code.

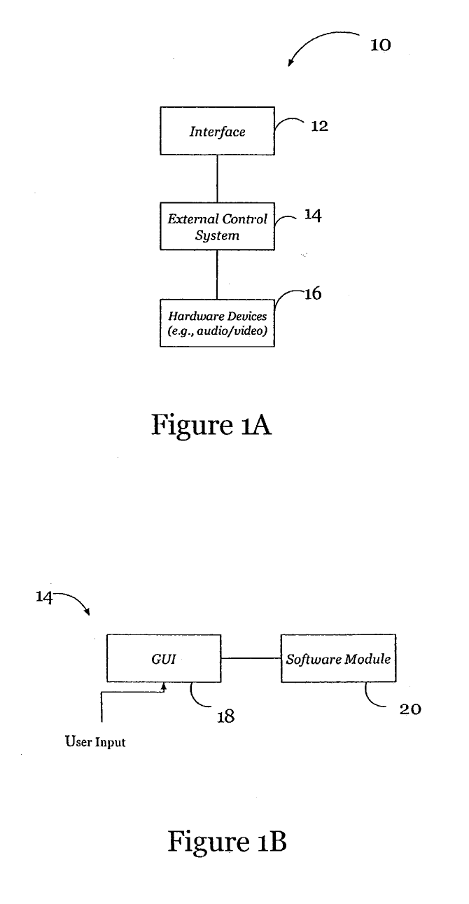

The overall system design is shown schematically in FIGS. 1A and 1B. In particular, with reference to FIG. 1A, system 10 includes a user interface 12 that incorporates programming schemes to facilitate ready communication between an external control system 14 and specific hardware 16, such as audio/video components. Turning to FIG. 1B, the programming interface preferably includes a graphical user interface (GUI) 18 and a software module 20 that allow the user to effectuate programming (for example, via decision trees of the GUI) of the components automatically, and without the drawbacks of current methods.

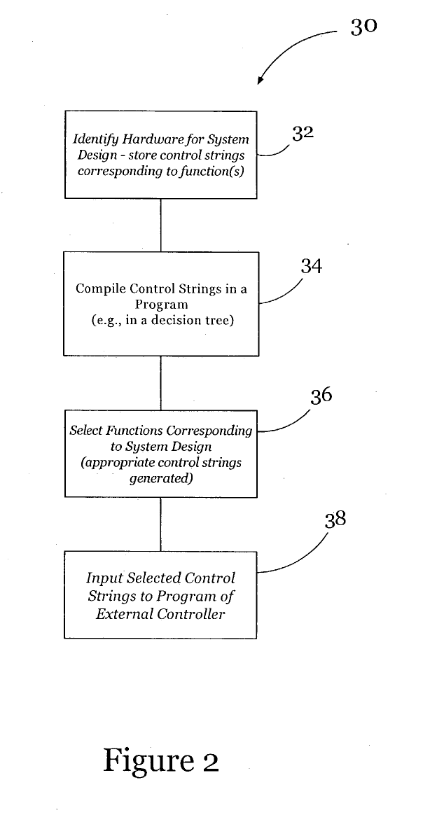

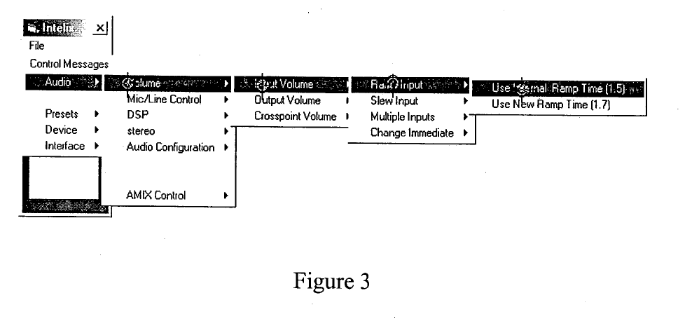

Turning to FIG. 2, a method 30 in which a user is able to readily integrate audio and video equipment, for example, with the program of an external controller according to a customer's selected design is shown. In Block 32 of method 30, the user identifies hardware so that software module 20 in FIG. 1B can process corresponding selections to gather control strings associated with the selected hardware. The control strings are then compiled in a decision tree in Block 34. In Block 36, the programmer selects one or more functions according to the particular system design via the GUI so as to allow software module to automatically generate selected control strings. The GUI is preferably implemented via a series of pull-down menus (see 40 in FIG. 3, for example) embodying the decision tree, where functions are accessed by the programmer via a series of prompted decisions. Preferably, when each function is selected an appropriate control string will be generated by method 30. Thereafter, the control strings are compiled in a program in Block 36.

Then, in Block 38, the method may include inputting the selected control string to an external control system program, such as NetLink Studio. One such example of this operation inputting step is as follows:

```
PROGRAM_NAME=‘PROGRAMMING AXCESS EXAMPLE’
(***********************************************************)
(*  DEVICE NUMBER DEFINITIONS GO BELOW  *)
(***********************************************************)
DEFINE_DEVICE
CD = 3  (* AXC-IR/S: CD PLAYER *)
RELAY = 5 (* AXC-REL8: SCREENS AND DRAPES *)
LIGHTS = 6 (* AXC-REL8: LOW VOLTAGE LIGHTING *)
SWT = 7 (* AXC-232: SWITCHER *)
VOLUME = 96 (* AXB-VOL3 *)
TP = 128 (* AXT-CA10: COLOR TOUCH PANEL *)
(***********************************************************)
(*  CONSTANT DEFINITIONS GO BELOW  *)
(***********************************************************)
DEFINE_CONSTANT
(* VOLUME *)
VOL_UP = 1 (* THESE CHANNELS AFFECT VOLUME LEVELS 1+2 *)
VOL_DN = 2
VOL_MUTE = 3
(* VOLUME **************************************************)
PUSH[TP,21]  (* VOLUME UP *)
  OFF[VOLUME,VOL_MUTE]
  TO[VOLUME,VOL_DN]
  “,$FA,$00,$05,$02,$03,$04,$03,$01”
}
PUSH[TP,23]  (* VOLUME MUTE *)
  [VOLUME,VOL_MUTE] = NOT [VOLUME,VOL_MUTE]
  “,$FA,$00,$05,$01,$0B,$01,$01,$01”
[TP,21] = [VOLUME,VOL_UP]
“,$FA,$00,$05,$02,$03,$02,$05,$B8”
[TP,22] = [VOLUME,VOL_DN]
[TP,23] = [VOLUME,VOL_MUTE]
PUSH[TP,24]  (* VOLUME PRESET *)
{
OFF[VOLUME,VOL_MUTE]
“,$FA,$00,$05,$01,$0B,$01,$01,$01”
WAIT 20 ‘STORE VOL PRESET’
  VOL_PRESET = VOL_LEVEL
```

As noted previously, the graphical user interface (GUI) is employed for ready presentation to the programmer at each step. As a result, system function is realized in an automated fashion without having to reference voluminous hard-copy code strings supplied by the hardware manufacturers.

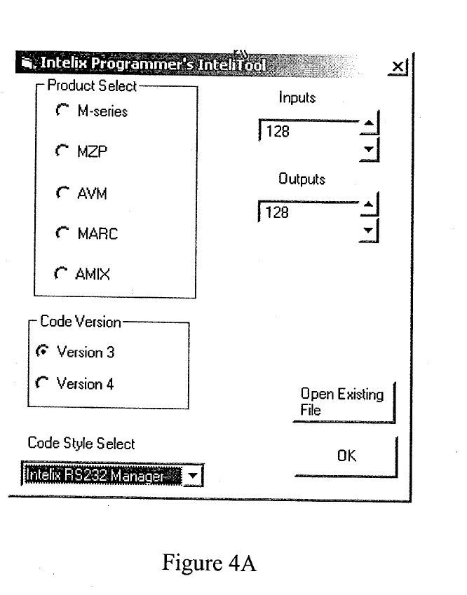

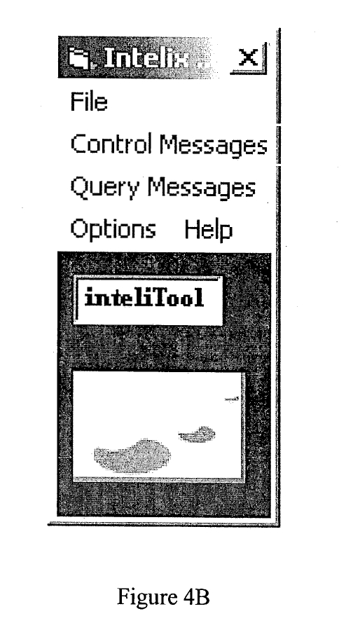

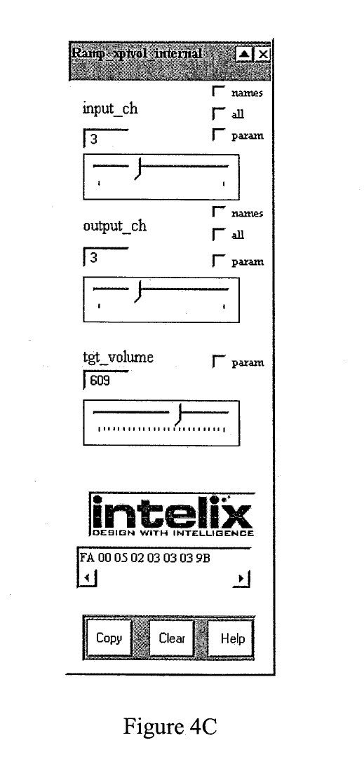

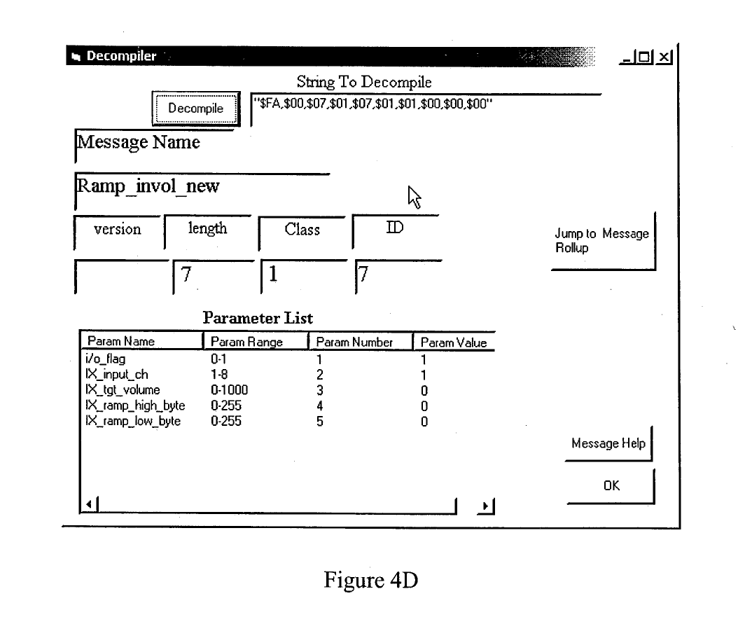

FIGS. 4A-4D illustrate the screen shots at each step of the programming process. FIG. 4A shows the InteliTool™ main screen where products may be selected, inputs/outputs defined, Code Style can be selected, etc. Then a sub window presents command options to the user, as shown in FIG. 4B. In FIG. 4C, the result of function selections made by the user via the decision tree (FIG. 3) is shown, yielding the “FA” control string shown. Finally, the decompiler which provides the instructions to the external control system (14 in FIG. 1A) based on the control strings is illustrated in FIG. 4D.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

1. A method of programming an external control system for audio and video hardware, comprising:
generating a decision tree based on a plurality of functions of the hardware, each function being associated with a corresponding control string;
selecting a function via the decision tree; and
determining a control string based on said selecting step.

2. The method of claim 1, further comprising programming the external control system with the control string.

3. The method of claim 1, further comprising selecting a plurality of functions and determining corresponding control strings, and compiling the control strings so as to program the external control system.

4. The method of claim 1, wherein said generating step includes selecting hardware and compiling corresponding control strings.

5. The method of claim 1, wherein the functions include at least one of a group including volume and audio configuration.

6. The method of claim 1, further comprising providing a diagnostic check of the control string.

7. The method of claim 6, wherein said providing step includes comparing the control string with a snooped control string.

8. A method of integrating audio and video hardware with an external control system, the method comprising the steps of:
providing a graphical user interface (GUI);
selecting a function associated with the hardware via the GUI so as to automatically generate a selected control string; and
inputting the selected control string to an external control system program.

9. A system for programming an external control system that controls audio and video equipment, the system comprising:
an interface including a graphical user interface (GUI) and a software module, wherein a user selects at least one function associated with the audio and video equipment via said GUI and said software module generates a corresponding control string.

10. The method of claim 9, wherein said software module includes a decision tree adapted to be presented to the user via said GUI, wherein said decision tree defines the at least one function associated with the audio and video equipment.

11. The method of claim 10, wherein said control string is input to the external control module.

12. The method of claim 9, wherein said software module determines an actual control string associated with the function and compares said control string to said actual control string.
